(19) United States
(12) Patent Application Publication
(10) Pub. No.: US 2022/0253962 A1
(43) Pub. Date: Aug. 11, 2022

(54) COMPUTER-IMPLEMENTED SYSTEM AND METHODS FOR GENERATING CRIME SOLVING INFORMATION BY CONNECTING PRIVATE USER INFORMATION AND LAW ENFORCEMENT INFORMATION

(71) Applicant: Morgan Wright, Ashburn, VA (US)

(72) Inventor: Morgan Wright, Ashburn, VA (US)

(21) Appl. No.: 17/169,993

(22) Filed: Feb. 8, 2021

(51) Int. Cl. G06Q 50/26; G06Q 50/00; G06Q 30/00; G06N 20/00; H04L 29/08; G06T 11/00

(52) U.S. Cl. CPC G06Q 50/265; G06Q 50/01; G06T 11/00; G06N 20/00; H04L 67/18; G06Q 30/018

(57) ABSTRACT

In some embodiments, a computer implemented system for generating crime solving information by connecting private user information and law enforcement information may perform steps of: receiving a private user social dataset having a number of social data fields from a first client device of a private user; receiving a case dataset describing a case, the case dataset having a number of case data fields from a second client device of a law enforcement user; identifying a social data field that matches a case data field; providing a first notification to a first client device of the private user that is associated with the identified social data field requesting the private user to provide crime solving information related to the case dataset; receiving crime solving information related to the case dataset from the first client device; and providing crime solving information related to the case dataset to the second client device.

### FIELD OF THE INVENTION

This patent specification relates to the field of systems and methods for connecting public and user-defined information to law enforcement investigations in order to generate tips, and in particular, to a system and method that enables user submitted public information relating to data, location, time, demographics and relation to be collected and compared to similar public information from cases law enforcement investigates in order to generate leads and tips.

### BACKGROUND

The public lacks a centralized automated internet-based system that collects user submitted public information relating to date, location, time, demographics and relation and compares that to similar public information from cases law enforcement investigates in order to generate leads and tips. Other public attempts (e.g., Crime Stoppers) utilize individual, unconnected, web sites that require the user to proactively continue to scan a limited number of local cases and cognitively determine if they have information relevant to a law enforcement case (a case being a collection of information about a particular instance of something, such as a person, company, incident or problem). There is no capability that is centrally managed that can proactively link information from a user to a law enforcement case and send a push notification. Information needed to generate a lead or tip on a police case isn't always located in the jurisdiction of the police agency. Publishing the information to social media requires the user have a connection to the agency publishing the information, not the information itself. Federal law enforcement agencies are prohibited by law from collecting non-criminal public information on American citizens, and privacy laws at the state and local level significantly restrict, including outright banning, the collection of similar information.

Therefore, a need exists for novel computer-implemented systems and methods that enables user submitted public information relating to date, location, time, demographics and relation to be collected and compared to similar public information from cases law enforcement investigates in order to generate leads and tips.

### BRIEF SUMMARY OF THE INVENTION

A system and methods for generating crime solving information by connecting private user information and law enforcement information are provided which allows private user submitted information to be compared against law enforcement user submitted information in a many-to-many operation in a centralized database, and when a connection between the user submitted information and law enforcement user submitted information is made between, a notification may be sent to the private user(s) and law enforcement user.

According to one embodiment consistent with the principles of the invention, a computer implemented method for generating crime solving information by connecting private user information and law enforcement information is provided. In some embodiments, the method may include the steps of: receiving a private user social dataset having a number of social data fields from a first client device of a private user; receiving a case dataset describing a case, the case dataset having a number of case data fields from a second client device of a law enforcement user; identifying a social data field that matches a case data field; providing a first notification to a first client device of the private user that is associated with the identified social data field requesting the private user to provide crime solving information related to the case dataset; receiving crime solving information related to the case dataset from the first client device; and providing crime solving information related to the case dataset to the second client device.

According to another embodiment consistent with the principles of the invention, a computer implemented system for generating crime solving information by connecting private user information and law enforcement information is provided. In some embodiments, the system may include: a private user database having a plurality of private user social datasets, each private user social dataset having a number of social data fields associated with a private user; a law enforcement case database having a plurality of case datasets, each case dataset having a number of case data fields describing a case; an association engine which may be configured to identify each private user social dataset having at least one social data field that matches at least one case data field; a user interface engine that may be configured to receive crime solving information related to the case from the client device of each private user that is associated with each identified private user social dataset, and the user interface engine may be configured to provide a first notification to a client device of each private user that is associated with each identified private user social dataset, the first notification requesting each private user to provide crime solving information related to the case described by the matched at least one case data field; and a case management engine that is configured to provide crime solving information related to the law enforcement case dataset to a client device associated with the case.

Numerous objects, features and advantages of the present invention will be readily apparent to those of ordinary skill in the art. Some example objects of the present invention are listed below.

One object of the present invention is to provide a system and methods which may be used to analyze the connections between the user and law enforcement case and calculates the strength of connection in order to allow the user to prioritize their interest.

Another object is to provide system and methods which, as crime solving information is received (leads are developed) by the system, the system may generate a dynamic map that allows law enforcement to visualize geographically where connections to their case are located, without identifying the user, in order to allocate investigative resources more efficiently.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a system for generating crime solving information by connecting private user information and law enforcement information according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating some applications of a system for generating crime solving information by connecting private user information and law enforcement information which may function as software rules engines according to various embodiments described herein.

FIG. 5 illustrates a block diagram illustrating an example of a system database according to various embodiments described herein.

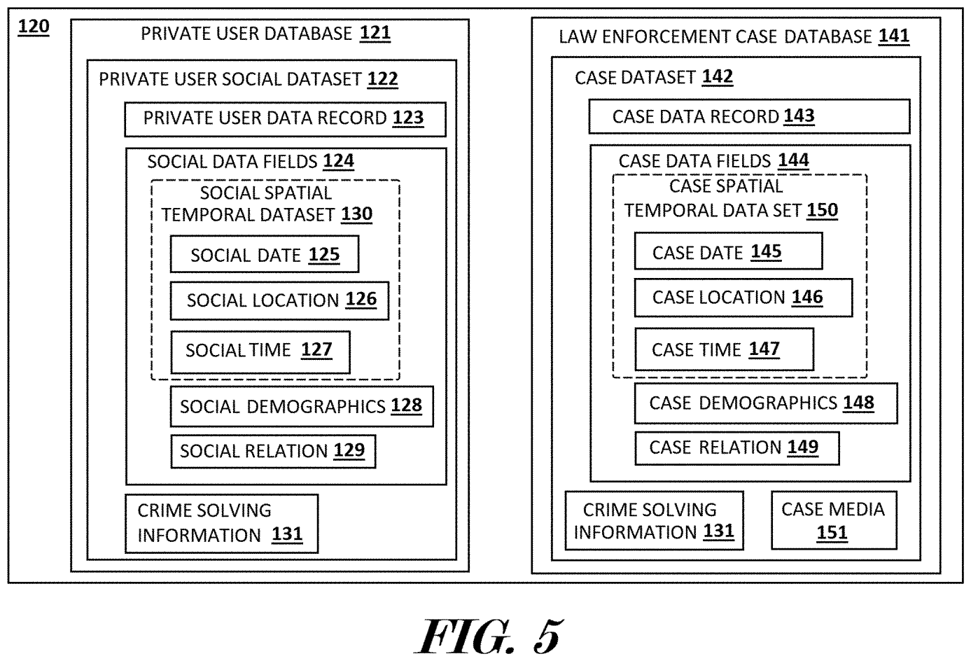

FIG. 6 shows a block diagram of an example of a computer-implemented method for providing crime solving information to a law enforcement user (officer) according to various embodiments described herein.

FIG. 7 depicts a block diagram of an example of a computer-implemented method for generating crime solving information by connecting private user information and law enforcement information according to various embodiments described herein.

FIG. 8A illustrates a first example of a dynamic map showing a geographic concentration of the number of connections or matches according to various embodiments described herein.

FIG. 8B shows a second example of a dynamic map showing a geographic concentration of the number of private users providing crime solving information according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DEFINITIONS

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for generating crime solving information by connecting private user information and law enforcement information are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

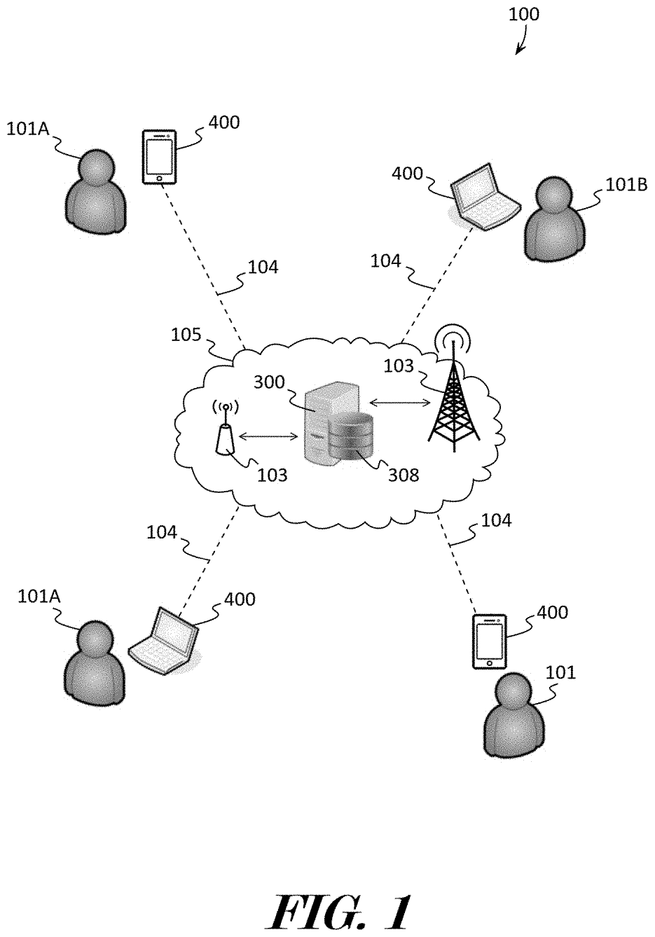

The present invention will now be described by example and through referencing the appended figures representing preferred and alternative embodiments. As perhaps best shown by FIG. 1, an illustrative example of some of the physical components which may comprise a system for generating crime solving information by connecting private user information and law enforcement information (“the system”) 100 according to some embodiments is presented. The system 100 is configured to facilitate the transfer of data and information between one or more access points 103, client devices 400, and servers 300 over a data network 105. Each client device 400 may send data to and receive data from the data network 105 through a network connection 104 with an access point 103. A data store 308 accessible by the server 300 may contain one or more databases 120. The data may comprise any information which may be used for generating crime solving information 131 by connecting private user information and law enforcement information, including information on or describing one or more users 101, information on or describing one or more solved and unsolved law enforcement cases, information on or describing one or more tips or crime solving information 131 provided by a user 101, links to or copies of media that may be associated with a law enforcement case, and any other information which may facilitate or be used to solve law enforcement cases.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or server 300 programmed to perform one or more of the steps described herein. In some embodiments, more than one client device 400 and/or server 300 may be used, with each being programmed to carry out one or more steps of a method or process described herein.

In some embodiments, the system 100 may be configured to facilitate the communication of information to and from one or more users 101, through their respective client devices 400, and servers 300 of the system 100. Users 101 of the system 100 may include one or more private users 101A and law enforcement users 101B. A private user 101A may comprise any individual that may desire to provide crime solving information 131 to one or more law enforcement agencies to assist the law enforcement agencies with solving open cases, open investigations, etc. A law enforcement user 101B may comprise an individual that may be a member of a law enforcement agency and which may be tasked with collecting crime solving information 131 for the purpose of solving one or more cases, assisting in open investigations, etc.

Generally, the system 100 may provide or function as a single repository that contains public case information or case data from law enforcement users 101B, and the social data provided by private users 101A or citizens looking to help. Every entered case in the system 100 may be analyzed for matches or connections between the social data, stored in social data fields 124 in a system database 120, that match case data, stored in case data fields 144 in a system database 120. When a match or connection is identified, the private user 101A associated with the identified social data may be notified through a notification to their client device 400, such as email, text, instant messaging, push notification, etc., that they might be connected to a case, and the notification may request the private user 101A to provide crime solving information 131 (commonly referred to a crime solving tip) related to the case. Tips can either be anonymous, or attributed to a private user 101A depending on the preference of the private user 101A, and the relevant law enforcement users 101B may be notified with the crime solving information 131 that the private user 101A inputs into the system 100. The system 100 does not require the use of any personally identifiable information (PII) of private users 101A or sensitive criminal justice information (CJIS). Preferably, if the information cannot be shared with the public, it cannot be used to make a connection in the system 100. The system 100 may provide an information portal, such as publicly accessible web site, application, etc., which may allow the private users 101A to input their social data, view cases and participate. Likewise, the system 100 may provide a law enforcement portal, such as privately accessible web site, application, etc., which may enable case data submission and crime solving information 131 or tip management.

In preferred embodiments, the system 100 may be configured to collect private user 101A submitted public information relating to date, location, time, demographics and relation of the private users 101A of the system 100 and compare that information to similar public information from cases that law enforcement users 101B are investigating in order to generate leads and tips which may be used to solve those cases. In further preferred embodiments, no private user 101A identifying information may be provided to law enforcement users 101B unless the private user 101A provides input authorizing their private user identifying information to be provided to a law enforcement user 101B. In further embodiments, the system 100 may be configured to identify and analyze data connections between one or more private users 101A and law enforcement cases and the system 100 may calculate the strength of the connections in order to allow a law enforcement user 101B to prioritize their interest in the identified connections. In further embodiments, the system 100 may be configured to generate a dynamic map 190A, 190B, or heat map a showing the concentration of possible leads/tips (crime solving information 131) geographically for each case that allows law enforcement users 101B to visualize geographically where connections to their case are located, without identifying the private user(s) 101A providing the crime solving information 131, in order to allocate investigative resources more efficiently.

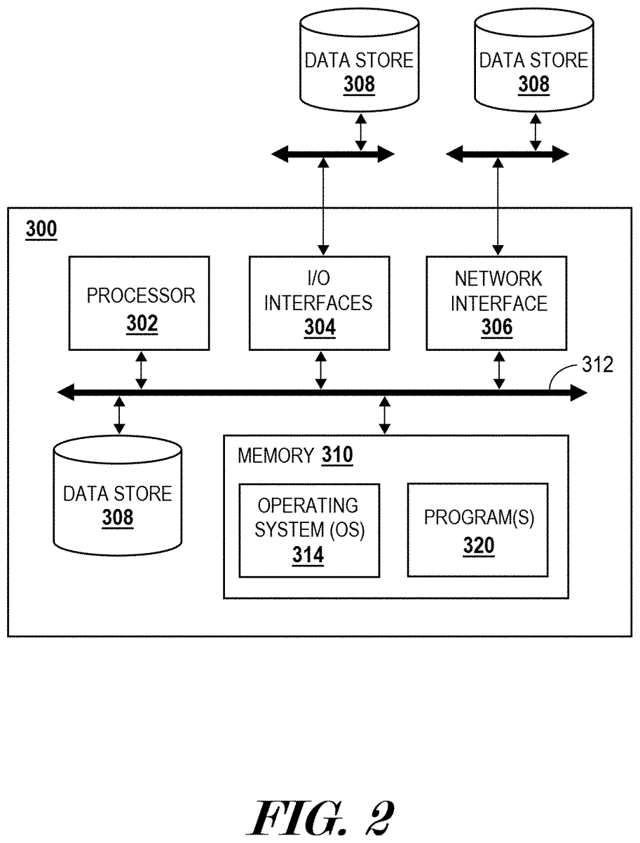

Referring now to FIG. 2, in an exemplary embodiment, a block diagram illustrates a server 300 of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

The one or more programs 320 may be configured to implement the various processes, algorithms, methods, techniques, etc. described herein.

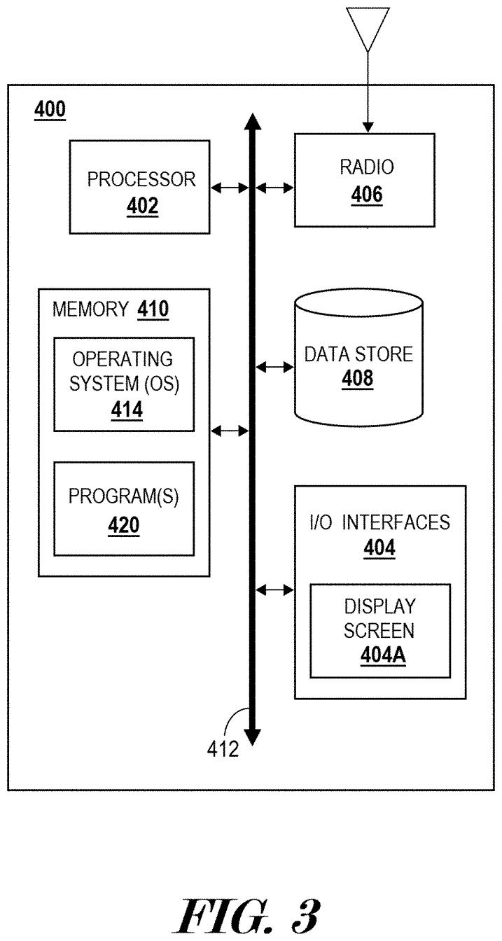

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display screen 404A, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

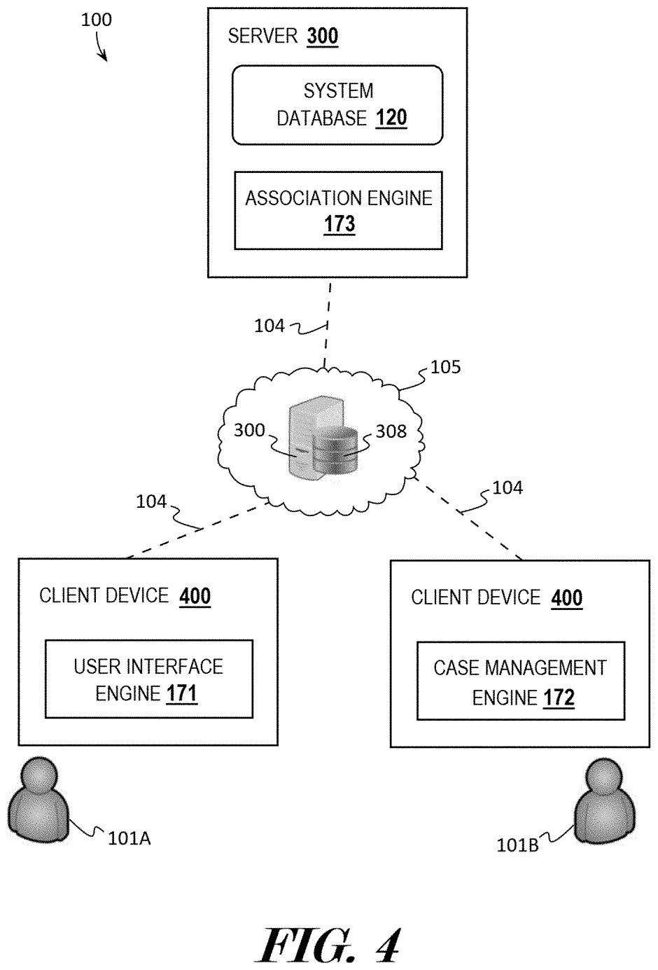

Referring now to FIG. 4 a block diagram showing some software rules engines and components which may be found in a system 100 and which may optionally be configured to run on one or more servers 300 and/or client devices 400 according to various embodiments described herein are illustrated. A server 300 and client device 400 may be in wired and/or wireless electronic communication through a network 105 with a data store 308. The engines 171, 172, 173, may be in electronic communication so that data may be readily exchanged between the engines 171, 172, 173, and one or more engines 171, 172, 173, may read, write, or otherwise access data in one or more databases 120 of one or more data stores 308.

In this and some embodiments, one or more servers 300 may be configured to run one or more software rules engines or programs such as an association engine 173 while one or more client devices 400 may be configured to run one or more software rules engines or programs such as a case management engine 172 and/or a user interface engine 171. In other embodiments, a user interface engine 171, case management engine 172, and/or association engine 173 may be configured to run on one or more servers 300 and/or client devices 400 with data transferred to and from a user interface engine 171, case management engine 172, and/or association engine 173 that may be in communication with a data store 308 through a network 105. It should be understood that the functions attributed to the engines 171, 172, 173, described herein are exemplary in nature, and that in alternative embodiments, any function attributed to any engine 171, 172, 173, may be performed by one or more other engines 171, 172, 173, or any other suitable processor logic.

The system 100 may comprise one or more databases, such as a system database 120, which may be stored on a data store 308 accessible to one or more engines 171, 172, 173. In some embodiments, a system database 120 may comprise any information which may be used for generating crime solving information 131 by connecting private user information and law enforcement information, including information on or describing one or more users 101, information on or describing one or more solved and unsolved law enforcement cases, information on or describing one or more tips or crime solving information 131 provided by a user 101, links to or copies of media that may be associated with a law enforcement case, and any other information which may facilitate or be used to solve law enforcement cases. It should be understood that the described structure of the system database 120 is exemplary in nature, and that in alternative embodiments, the data contained within the system database 120 may be organized in any other way.

In some embodiments, a system database 120 may comprise a private user database 121 which may store social data describing and provided by one or more private users 101A. The private user database 121 may comprise a private user social dataset 122 for each private user 101A of the system 100 so that each private user social dataset 122 may comprise social data specific to an individual private user 101A of the system 100. Each private user social dataset 122 may comprise a private user data record 123 and one or more social data fields 124.

In some embodiments, a private user data record 123 may comprise identifying information for a private user 101A, also referred to as private user identifying information, such as the user's name, address, phone numbers, email addresses, messaging service identifiers, and any other information which may be used to identify and/or contact a private user 101A.

In some embodiments, social data fields 124 of a private user social dataset 122 may comprise one or more social date data records 125, social location data records 126, social time data records 127, social demographics data records 128, and social relation data records 129. Generally, data contained in social data fields 124 may be likened to social strands that may function like social DNA in that they may be used to help establish a connection and identity, they may be used to connect people to people, and may be used to connect people to law enforcement cases. Furthermore, data contained in social data fields 124 may be descriptive of a private user 101A, but preferably the data an individual social data field 124 may not provide or contain enough information to identify the private user 101A.

In preferred embodiments, a private user social dataset 122 may comprise one or more social date data records 125, social location data records 126, and social time data records 127 that may be associated together to function as spatial temporal data that may be describe date, location and time data for a private user 101A. Generally, a social date data record 125, social location data record 126, and social time data record 127 may be associated together as a social spatial temporal dataset 130. In this manner, a private user social dataset 122 may comprise a number of social spatial temporal datasets 130 with each social spatial temporal dataset 130 containing data describing the date and time period that a private user 101A was at a geographic location. For example, in order to describe a private user 101A attending a concert, a private user social dataset 122 may comprise a social spatial temporal dataset 130 comprising a social date data record 125, social location data record 126, and social time data record 127 that may be associated together in which the social date data record 125 contains the date of the concert, the social location data record 126, contains the geographical location of the concert, and the social time data record 127 contains data describing the time period that the private user 101A was at the geographical location of the concert. In some embodiments, data populating a social spatial temporal dataset 130 may be manually entered by a private user 101A via their client device 400. In further embodiments, data populating a social spatial temporal dataset 130 may be recorded by the client device 400 of a private user 101A and then automatically uploaded to the system 100 by the client device 400.

In preferred embodiments, a private user social dataset 122 may comprise a social demographics data record 128 for each private user 101A. A social demographics data record 128 may contain data describing demographic information of a private user 101A, such as interests, likes, preferences, hobbies, etc. For example, a social demographics data record 128 for a private user 101A may describe that the private user 101A is interested in mountain biking, model airplanes, and dogs.

In preferred embodiments, a private user social dataset 122 may comprise a social relation data record 129 for each private user 101A. A social relation data record 129 may contain data describing relational information of a private user 101A, such as employment history, education history, past addresses, events that the private user 101A participated in, etc. For example, a social relation data record 129 for a private user 101A may describe that the private user 101A worked for Wal-Mart and describe the time period that the private user 101A was employed and location of the Wal-Mart that they worked at.

The system database 120 may store crime solving information 131 that may be submitted by private users 101A. Optionally, crime solving information 131 may be stored in a private user social dataset 122, in a case dataset 142, etc. Generally, crime solving information 131 may comprise data submitted by private users 101A that may be considered as crime solving tips, leads, etc. For example, crime solving information 131 may comprise a description of a suspicious person or suspect, a description of a vehicle seen near a crime screen, one or more license plate characters of a vehicle seen near a crime screen, the last time and place a private user 101A saw a victim of a crime, etc.

In some embodiments, a system database 120 may comprise a law enforcement case database 141 which may store case data describing one or more cases that may be provided by one or more law enforcement users 101B. The law enforcement case database 141 may comprise a case dataset 142 for each case of the system 100 so that each case dataset 142 may comprise case data specific to an individual case of the system 100. Each case dataset 142 may comprise a case data record 143 and one or more case data fields 144.

In preferred embodiments, a case data record 143 may comprise a brief description of the case which may be provided to private users 101A that have one or more social data fields 124 matching one or more case data fields 144 of the case of the case data record 143. This brief description may include: age, sex, clothing, and other descriptors of the victim; age, sex, clothing, and other descriptors of a suspect; and what crime occurred and/or why the case was opened.

In some embodiments, a case data record 143 may comprise identifying information for a case, also referred to as case identifying information, such as the code name, brief case descriptor, case number, etc. A case data record 143 may comprise information identifying one or more law enforcement users 101B that may be handling the case, and this information may comprise a contact address, phone numbers, email addresses, messaging service identifiers, and any other information which may be used to identify a case and contact law enforcement users 101B that may be handling or otherwise associated with the case.

In some embodiments, case data fields 144 may comprise one or more case date data records 145, case location data records 146, case time data records 147, case demographics data records 148, and case relation data records 149. Generally, data contained in case data fields 144 may contain any information related to a case that a law enforcement user 101B desires to enter into the system 100.

In preferred embodiments, a case dataset 142 may comprise one or more case date data records 145, case location data records 146, and case time data records 147 that may be associated together to function as case spatial temporal data that may be describe location and time data for a case. Generally, a case date data record 145, case location data record 146, and case time data record 147 may be associated together as a case spatial temporal dataset 150. In this manner, a case dataset 142 may comprise a number of case spatial temporal datasets 150 with each case spatial temporal dataset 150 containing data describing the actual or approximate date and time period a case occurred at a geographic location. For example, in order to describe a homicide case, a case dataset 142 may comprise a case spatial temporal dataset 150 comprising a case date data record 145, case location data record 146, and case time data record 147 that may be associated together in which the case date data record 145 contains the date of the homicide, the case location data record 146, contains the geographical location of the homicide, and the case time data record 147 contains data describing the time period that the homicide occurred or most likely occurred at the geographical location. In some embodiments, data populating a case spatial temporal dataset 150 may be manually entered by a law enforcement user 101B via their client device 400. In further embodiments, data populating a case spatial temporal dataset 150 may be uploaded to the system 100 from a law enforcement client device, database, application, etc.

In preferred embodiments, a case dataset 142 may comprise a case demographics data record 148 for each case entered into the system 100. A case demographics data record 148 may contain data describing demographic information of a victim, suspect, or other individual associated with the case, such as interests, likes, preferences, hobbies, etc. For example, a case demographics data record 148 for a victim of a homicide may describe that the victim was interested in mountain biking, hiking, and cats.

In preferred embodiments, a case dataset 142 may comprise a case relation data record 149 for each case. A case relation data record 149 may contain data describing relational information of a victim, suspect, or other individual associated with the case, such as employment history, education history, past addresses, events that the private user a victim, suspect, or other individual associated with the case participated in, etc. For example, a case relation data record 149 for a homicide case may describe that the victim worked for Wal-Mart and describe the time period that the victim was employed and location of the Wal-Mart that they worked at.

In preferred embodiments, a case dataset 142 may comprise a case media data record 151 which may comprise or otherwise provide access to media associated with the case of the case dataset 142 that a law enforcement user 101B may desire to allow a private user 101A having one or more social data fields 124 that match one or more case data fields 144 to view or have access to in order to aid solving the case and/or to elicit crime solving information 131 from the private user 101A. For example, a case media data record 151 may comprise or provide a link to a news report, print article, online article, television program, photos, videos, etc., on the case. Preferably, the system 100 may not match case media data records 151 to social data fields 124, but the media may add valuable content for a private user 101A to visualize the information about the crime and see if they happen to recognize a photo of the victim (or suspect).

The system 100 may comprise one or more user interface engines 171. A user interface engine 171 may comprise or function as interface logic stored in a memory 310, 410, which may be executable by the processor 302, 402, of a server 300 and/or client device 400. In addition to any other functions described below, in some embodiments, a user interface engine 171 may be configured to provide or generate a user interface on a display screen 404A of a client device 400 which may be used by a private user 101A to provide data to and receive data from the system 100. For example, a user interface engine 171 may comprise a web portal, application, etc., which may be used by a private user 101A to provide data to and receive data from the system 100 via their client device 400. In further embodiments, a private user 101A may grant access for a user interface engine 171 to collect social data automatically from their client device 400. In still further embodiments, a user interface engine 171 may be configured to provide notifications to the client devices 400 of private users 101A, such as when a private user 101A has one or more social data fields 124 that matches one or more case data fields 144.

The system 100 may comprise one or more case management engines 172. A case management engine 172 may comprise or function as management logic stored in a memory 310, 410, which may be executable by the processor 302, 402, of a server 300 and/or client device 400. In addition to any other functions described below, in some embodiments, a case management engine 172 may be configured to provide or generate a user interface on a display screen 404A of a client device 400 which may be used by a law enforcement user 101B to provide data to and receive data from the system 100. For example, a case management engine 172 may comprise a web portal, application, etc., which may be used by a law enforcement user 101B to provide data to and receive data from the system 100 via a client device 400. In still further embodiments, a case management engine 172 may be configured to provide notifications to the client devices 400 of law enforcement users 101B, such as when a private user 101A has one or more social data fields 124 that matches one or more case data fields 144.

The system 100 may comprise one or more association engines 173. An association engine 173 may comprise or function as association logic stored in a memory 310, 410, which may be executable by the processor 302, 402, of a server 300 and/or client device 400. In addition to any other functions described below, in some embodiments, an association engine 173 may be configured to analyze social data, stored in social data fields 124 in a system database 120, and case data, stored in case data fields 144 in a system database 120, and the association engine 173 may identify social data fields 124 that match case data fields 144. In further embodiments, an association engine 173 may be configured to generate a 190A, 190B, or heat map which may be displayed on a display screen 404A of a client device 400 showing the concentration of possible leads/tips (crime solving information 131) geographically for each case that allows law enforcement users 101B to visualize geographically where connections to their case are located, without identifying the private user(s) 101A having one or more social data fields 124 that match one or more case data fields 144 of a case, in order to allocate investigative resources more efficiently.

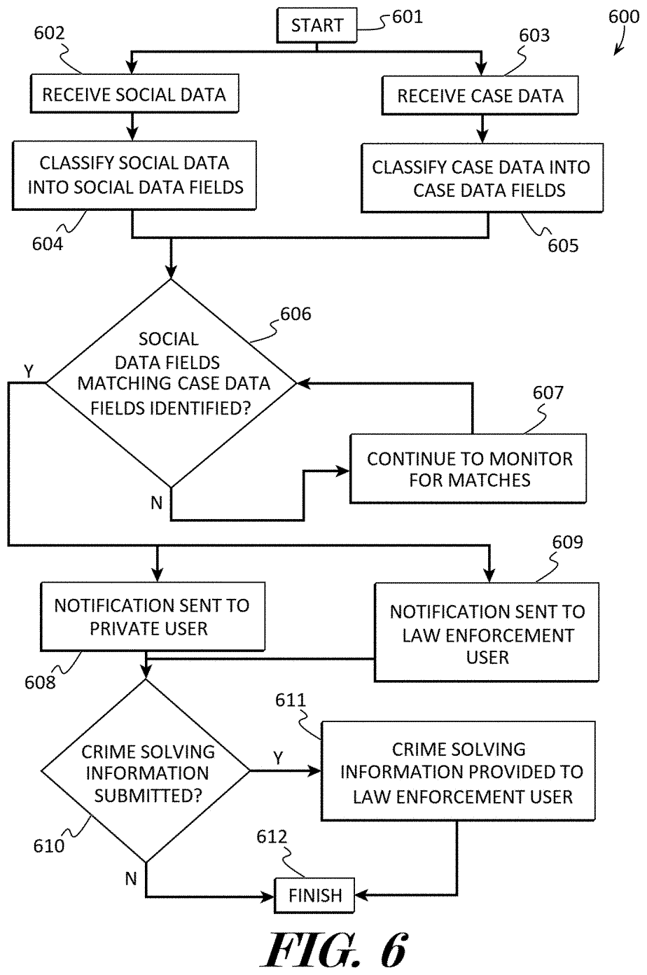

FIG. 6 shows a block diagram of an example of a computer-implemented method for providing crime solving information to a law enforcement officer (“the method”) 600 according to various embodiments described herein. In some embodiments, the method 600 may be used to enable the communication of information between the client devices 400 of one or more private users 101A and law enforcement users 101B in which the private users 101A have one or more social data fields 124 that match one or more case data fields 144 of a case entered into the system 100 by the law enforcement users 101B. One or more steps of the method 600 may be performed by a user interface engine 171, case management engine 172, and/or association engine 173 which may be executed by a computing device processor, such as a processor 302 (FIG. 2) and/or a processor 402 (FIG. 3).

In some embodiments, the method 600 may start 601 and social data may be received in step 602 and case data may be received in step 603.

Social data may be received in step 602 by a user interface engine 171 via input received from a client device 400 of each private user 101A. In some embodiments, a user interface engine 171 may be configured to provide or generate a user interface on a display screen 404A of a client device 400 which may be used by a private user 101A to provide social data to the system 100. In further embodiments, a private user 101A may grant access for a user interface engine 171 to collect social data automatically from their client device 400, such as by automatically collecting location data from the client device 400 so that a social data field 124 of a private user 101A may comprise location data of the private user 101A that may be generated by the client device 400 of the private user 101A.

After step 602, the method 600 may proceed to step 604 in which the social data provided by each private user 101A may be classified into social data fields 124 which may be stored in a private user social dataset 122 for each respective private user 101A. In some embodiments, a user interface engine 171 may be configured to classify the social data into the social data fields 124 based on the type of data received. For example, demographic social data may be classified into social demographics data records 128. After step 604, the method 600 may proceed to decision block 606.

Case data may be received in step 603 by a case management engine 172 via input received from a client device 400 of one or more law enforcement users 101B. In some embodiments, a case management engine 172 may be configured to provide or generate a user interface on a display screen 404A of a client device 400 which may be used by a law enforcement user 101B to provide case data to the system 100.

After step 603, the method 600 may proceed to step 605 in which the case data provided by each law enforcement user 101B may be classified into case data fields 144 which may be stored in a case dataset 142 for each respective case entered into the system 100. In some embodiments, a case management engine 172 may be configured to classify the case data into the case data fields 144 based on the type of data received. For example, case date data may be classified into case date data records 145. After step 605, the method 600 may proceed to decision block 606.

In decision block 606, an association engine 173 may identify if any of the social data fields 124 match any of the case data fields 144. For example, if a private user 101A has provided social data populating a social spatial temporal dataset 130 that indicates that the private user 101A was at a geographic location at or proximate to the same geographic location of a case spatial temporal dataset 150 at the same date and the same or approximately the same time, then the association engine 173 may identify a match (also called a connection) between the social data fields 124 of the private user 101A and the case data fields 144 of the case.

If no social data fields 124 and case data fields 144 matches are identified in decision block 606, the method 600 may continue to step 607 and the association engine 173 may continue to monitor for matches between the social data fields 124 of the private user database 121 and case data fields 144 of the law enforcement case database 141.

If one or more social data fields 124 and case data fields 144 matches are identified in decision block 606, the method 600 may continue to step 608 and to step 609.

In step 608, a notification may be sent to each private user 101A that has one or more matching social data fields 124 by sending a notification to the respective client device 400 of each private user 101A. A notification may comprise a text message, instant message, or the like, email, phone call, etc. which may be provided to the client device 400 of any private user 101A having at least one social data field 124 that matches a case data field 144. Optionally, a notification may only be sent to a private user 101A that has two, three, four, or other threshold, of matching social data fields 124.

In some embodiments, the notification may comprise data from a case data field 144 of the case dataset 142, such as data from one or more of the: case date data record 145, case location data record 146, case time data record 147, case demographic data record 148, and case relation data record 149. In further embodiments, the notification may comprise data from a case data record 143 of the case, such as a brief description of the case that may include: age, sex, clothing, and other descriptors of the victim; age, sex, clothing, and other descriptors of a suspect; and what crime occurred and/or why the case was opened. In still further embodiments, the notification may comprise data from a case media data record 151 of the case dataset 142 that may comprise or otherwise provide access to media associated with the case of the case dataset 142 such as a news report, print article, online article, television program, photos, videos, etc., on the case.

In step 609, a notification may be sent to one or more law enforcement users 101B associated with the case data set 142 that has one or more matching case data fields 144 by sending a notification to the respective client device 400 of the law enforcement users 101B. A notification may comprise a text message, instant message, or the like, email, phone call, etc. which may be provided to the client device 400 of a law enforcement user 101B when at least one case data field 144 is matched with a social data field 124 of a private user 101A. Optionally, a notification may only be sent to a law enforcement user 101B when a private user 101A has two, three, four, or other threshold, of matching social data fields 124.

In preferred embodiments, no private user identifying information is provided to a client device 400 of a law enforcement user 101B unless a private user 101A having matching social data fields 124 provides input, via their respective client device 400, authorizing their private user identifying information that is contained in their private user data record 123 to be provided to a law enforcement user 101B. In this manner, while a law enforcement user 101B may be notified by the system 100 that one or more users has one or more social data fields 124 matching one or more case data fields 144 of their case, the system 100 may enable the one or more private users 101A to be anonymous to the law enforcement user 101B at the preference of each private user 101A.

After step 608, the method 600 may continue to decision block 610 and the system 100 may determine if crime solving information 131 has been submitted to the system 100 by a private user 101A that received a notification in step 608. If a private user 101A that received a notification in step 608, decides that they want to provide crime solving information 131, they may enter it through their client device 400 via a user interface engine 171 and the method 600 may proceed to step 611. If a private user 101A that received a notification in step 608, decides that they do not want to provide crime solving information 131, the method 600 may finish 612 for that private user 101A.

In step 611, any crime solving information 131 that was provided by a private user 101A that received a notification in step 608 may be provided to a client device 400 of a law enforcement user 101B via a case management engine 172, such as via a text message, instant message, or the like, email, phone call, etc. Preferably, a case management engine 172 may provide the crime solving information 131 to a law enforcement user 101B via a graphical user interface that may be generated on a display screen 404A of the client device 400 of a law enforcement user 101B. After step 611, the method 600 may finish 612.

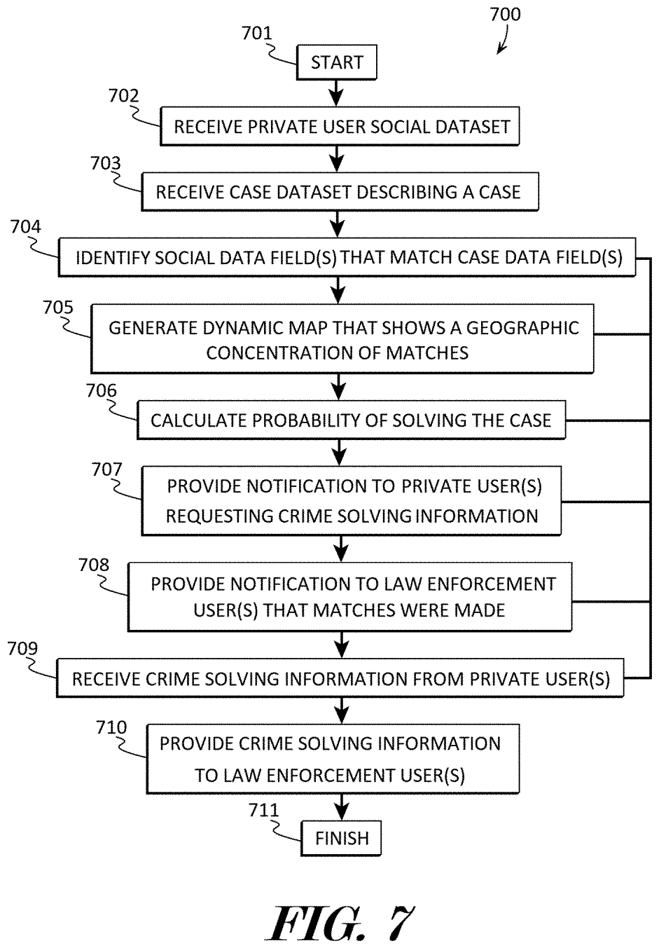

FIG. 7 shows a block diagram of an example of a computer-implemented method for generating crime solving information by connecting private user information and law enforcement information (“the method”) 700 according to various embodiments described herein. In some embodiments, the method 700 may be used to enable the communication of information between the client devices 400 of one or more private users 101A and law enforcement users 101B in which the private users 101A have one or more social data fields 124 that match one or more case data fields 144 of a case entered into the system 100 by the law enforcement users 101B and to provide the law enforcement users 101B with data which may assist the law enforcement users 101B in solving a case. One or more steps of the method 700 may be performed by a user interface engine 171, case management engine 172, and/or association engine 173 which may be executed by a computing device processor, such as a processor 302 (FIG. 2) and/or a processor 402 (FIG. 3).

In some embodiments, the method 700 may start 701 and one or more private user social datasets 122 may be received in step 702, in which each social dataset 122 may have a number of social data fields 124, such as a social date data record 125, social location data record 126, social time data record 127, social demographics data record 128, and social relation data record 129. In some embodiments, social data may be received by a user interface engine 171 from a client device 400 of each private user 101A, and the user interface engine 171 may classify the social data into the social data fields 124 based on the type of data received. In preferred embodiments, at least one of the social data fields 122 of a private user social dataset 122 may comprise private user location data generated by the client device 400 of the respective private user 101A.

In step 703, one or more case datasets 142 may be received, in which each case dataset 142 describes a case and each case dataset 142 has a number of case data fields 144, such as a case date data record 145, case location data record 146, case time data record 147, case demographics data record 148, and case relation data record 149. In some embodiments, case data may be received by a case management engine 172 from a client device 400 of a law enforcement user 101B associated with a respective case, and the case management engine 172 may classify the case data into the case data fields 144 based on the type of data received.

In step 704, one or more of the social data fields 124 that match one or more case data fields 144 may be identified. In some embodiments, an association engine 173 may compare the social data fields 124 and case data fields 144 and identify if any of the social data fields 124 match any of the case data fields 144. For example, if a private user 101A has provided social data populating a social demographics data record 128 that indicates that a private user 101A was interested in the same hobby as a victim in a case as stored in a case demographics data record 148, then the association engine 173 may identify that those social data fields 124 of the private user 101A and the case data fields 144 match.

After step 704, the method 700 may optionally proceed to step 705, 706, 707, or 708.

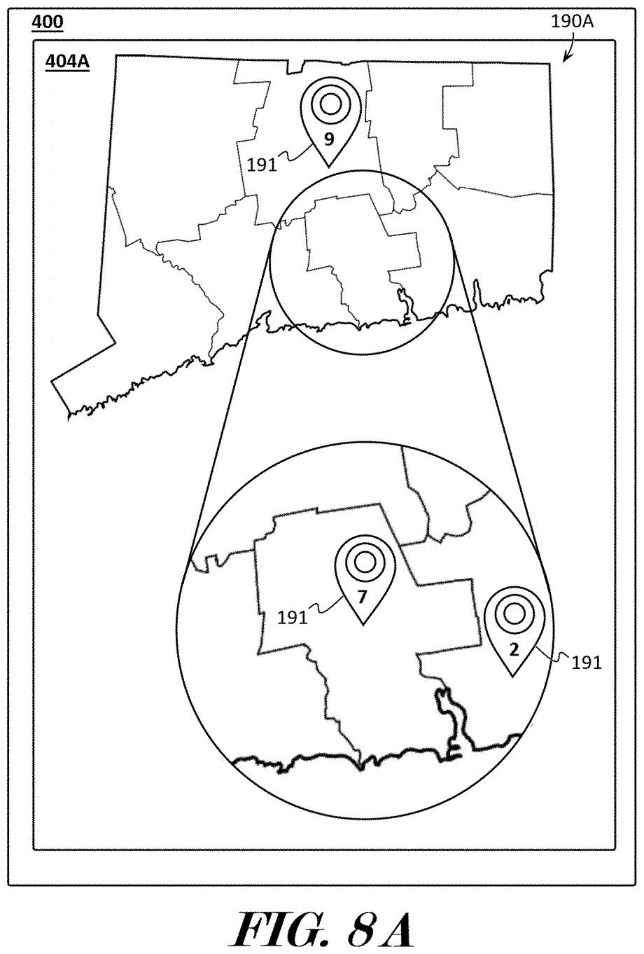

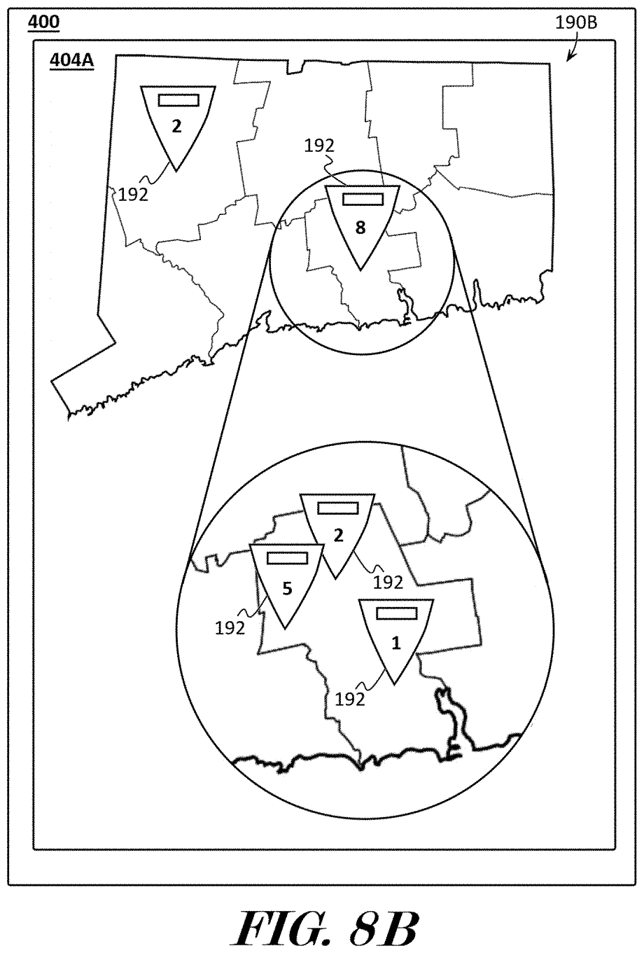

In optional step 705, a dynamic map 190A, 190B, may be generated on a display screen 404A of a client device 400 of a law enforcement user 101B by an association engine 173. In some embodiments, a dynamic map 190A, 190B, may show a geographic concentration of any social data fields 124 that match case data fields 144 for a particular case dataset 142 or case. In further embodiments, a dynamic map 190A, 190B, may be generated by an association engine 173 that maps the geographic concentration of any social data fields 124 that match case data fields 144 based on a zip code or other geographic breakdown of each private user 101A having one or more social data fields 124 that match case data fields 144 for a particular case dataset 142 or case. For example, an association engine 173 may generate a dynamic map 190A, 190B, that displays every zip code where a connection to the case has been made based on the zip code of the private user 101A, such as which may be stored in a private user data record 123 or other social data field 124 of the respective social user 101A, along with displaying the number of connections or matches 191 made in the displayed zip codes. For example, and as shown in FIG. 8A, if nine private users 101A have previously lived in the same state as a victim of a case (such as may be stored in a case data record 143, case location data record 146, etc.) then optionally, an association engine 173 may generate a dynamic map 190A may display the number of connections or matches 191 by county or other geographical breakdown. Preferably, if seven private users 101A have previously lived in the same zip code as a victim of a case (such as may be stored in a case data record 143, case location data record 146, etc.) then a dynamic map 190A may display the number “7” as number of connections or matches 191 in that zip code. If other private users 101A have one or more social data fields 124 matching one of the case data fields 144 and the private users 101A are associated with that same zip code, then each match may be added to the count or number of connections or matches 191 made in that zip code.

In some embodiments, a dynamic map 190A, 190B, may be generated by an association engine 173 that maps the geographic concentration of private users 101A providing crime solving information 131 for the case of a case dataset 142. For each private user that provides crime solving information 131 in step 708, the association engine 173 may count each private user 101A and plot the count as the number of private users providing crime solving information 192 in a geographic location. In this manner, an association engine 173 may map the geographic concentration of private users 101A providing crime solving information 131 based on a zip code or other geographic breakdown of each private user 101A providing crime solving information 131, those private users 101A optionally having one or more social data fields 124 that match case data fields 144 for a particular case dataset 142 or case. For example and as shown in FIG. 8B, if ten private users 101A provide crime solving information 131 for the case of a case dataset 142 in step 708, with two of those private users 101A living in a first county and eight of those private users 101A living in a second county, then the association engine 173 may generate a dynamic map 190B having “2” as the number of private users providing crime solving information 192 with the “2” drawn over the first county and having “8” as the number of private users providing crime solving information 192 with the “8” drawn over the second county. Furthermore, the association engine 173 may generate the dynamic map 190B breaking down the private users 101A by zip code. For example, if eight private users 101A provide crime solving information 131 for the case in a county having at least three zip codes, with five of those private users 101A living in a first zip code, one of those private users 101A living in a second zip code, and two of those private users 101A living in a third zip code, then the association engine 173 may generate a dynamic map 190B having a “5” drawn over the first zip code, a “1” drawn over the second zip code, and a “2” drawn over the third zip code.

In step 706, a probability of solving the case may be calculated by an association engine 173. In some embodiments, an association engine 173 may calculate the probability of solving the case based on the amount or number of crime solving information received 131, the geographic concentration of the crime solving information received 131 and/or the geographic concentration of social data fields 124 matching case data fields 144, and the number of social data fields 124 matching case data fields 144. In still further embodiments, as the number of social data fields 124 matching case data fields 144 of a case increases, the association engine 173 may calculate that the probability of solving the case increases. For example, the association engine 173 may calculate that the probability of solving the case increases from 75 percent to 85 percent as the number of social data fields 124 matching case data fields 144 of a case increases from 35 matches to 43 matches. In preferred embodiments, an association engine 173 may comprise or otherwise have access to AI/ML (artificial intelligence/machine learning) which may be used to calculate the probability of solving a case based on the amount or number of crime solving information received 131, the geographic concentration of the crime solving information received 131 and/or the geographic concentration of social data fields 124 matching case data fields 144, and the number of social data fields 124 matching case data fields 144. This probability may be provided to a law enforcement user 101B, such as by displaying it on a display screen 404A of their client device 400, however, the association engine 173 may only provide a law enforcement user 101B with aggregated data—not specific data that could identify the one or more private users 101A that the data is sourced from.

In addition to the example above and as a further example, a match or correlation between the case and a private user 101A may be made by an association engine 173 based on where the subject of the case (victim/suspect/witness) worked or went to school and the association engine 173 may correlate that to other private users 101A who worked at the same company or went to the same school. If the subject and a private user 101A both worked in the same zip code for the same company, a higher degree of correlation may be assigned by the association engine 173. If the subject and private user 101A also attended the same school (e.g., university) where their attendance overlapped then an even higher degree of correlation may be assigned by the association engine 173.

In step 707, a notification may be provided to the client device 400 of the private user 101A that is associated with the one or more identified social data fields 124 that match the one or more case data fields 144, and the notification may request the private user 101A to provide crime solving information 131 related to the case dataset 142 of the case. A notification may comprise a text message, instant message, or the like, email, phone call, etc. which may be provided to the client device 400 of any private user 101A having at least one social data field 124 that matches a case data field 144. Optionally, a notification may only be sent to a private user 101A that has two, three, four, or other threshold, of matching social data fields 124.

In some embodiments, the notification may comprise data from a case data field 144 of the case dataset 142, such as data from one or more of the: case date data record 145, case location data record 146, case time data record 147, case demographic data record 148, and case relation data record 149. In further embodiments, the notification may comprise data from a case data record 143 of the case, such as a brief description of the case that may include: age, sex, clothing, and other descriptors of the victim; age, sex, clothing, and other descriptors of a suspect; and what crime occurred and/or why the case was opened. In still further embodiments, the notification may comprise data from a case media data record 151 of the case dataset 142 that may comprise or otherwise provide access to media associated with the case of the case dataset 142 such as a news report, print article, online article, television program, photos, videos, etc., on the case.

In further preferred embodiments, an association engine 173 may comprise or otherwise have access to AI/ML (artificial intelligence/machine learning) which may be used to calculate the strength of social data field 124 and case data field 144 matches or connection to a particular case to allow a private user 101A and/or law enforcement user 101B to filter results based on probability. For example, the system 100 may only provide a notification to the client device 400 of a private user 101A associated with a case (associated by having one or more social data fields 124 matching one or more case data fields 144) if there is a 50% probability, or other private user 101A selected probability threshold, that the private user 101A is connected to the case. As a further example, the fact that a private user 101A and a case victim both worked for the same company the association engine 173 creates a match or connection of the private user 101A to the case. If the private user 101A and victim worked during overlapping time periods, the association engine 173 may calculate that the probability increases. If the private user 101A and victim worked at the same company during the same dates in the same zip code, then the association engine 173 may calculate that the probability further increases.

In step 708, a notification may be sent to one or more law enforcement users 101B associated with the case data set 142 that has one or more matching case data fields 144 by sending a notification to the respective client device 400 of the law enforcement users 101B. A notification may comprise a text message, instant message, or the like, email, phone call, etc. which may be provided to the client device 400 of a law enforcement user 101B when at least one case data field 144 is matched with a social data field 124 of a private user 101A. Optionally, a notification may only be sent to a law enforcement user 101B when a private user 101A has two, three, four, or other threshold, of matching social data fields 124.

In preferred embodiments, no private user identifying information is provided to a client device 400 of a law enforcement user 101B unless a private user 101A having matching social data fields 124 provides input, via their respective client device 400, authorizing their private user identifying information that is contained in their private user data record 123 to be provided to a law enforcement user 101B. In this manner, while a law enforcement user 101B may be notified by the system 100 that one or more users has one or more social data fields 124 matching one or more case data fields 144 of their case, the system 100 may enable the one or more private users 101A to be anonymous to the law enforcement user 101B at the preference of each private user 101A.

In step 709, crime solving information 131 related to the case dataset 142 of the case may be received from the one or more private users 101A via their respective client devices 400. If a private user 101A that received a notification in step 707, decides that they want to provide crime solving information 131, they may enter it through their client device 400 via a user interface engine 171, and the interface engine 171 may provide the crime solving information 131 to the system database 120.

In step 710, the crime solving information 131 of step 709 may be provided to one or more law enforcement users 101B associated with the case by providing the crime solving information 131 to the client device 400 of the respective law enforcement user(s). Optionally, any crime solving information 131 that was provided by a private user 101A that received a notification in step 709 may be provided to a client device 400 of a law enforcement user 101B via a case management engine 172, such as via a text message, instant message, or the like, email, phone call, by being displayed on a display screen 404A of their client device 400, etc. Preferably, a case management engine 172 may provide the crime solving information to a law enforcement user 101B via a graphical user interface that may be generated on a display screen 404A of the client device 400 of a law enforcement user 101B. After step 710, the method 700 may finish 711.

System 100 Operation Example

An individual may enroll in the system 100 as a private user 101A, and they may voluntarily provide social information to the private user database 121 to create a comprehensive private user social dataset 122 or profile, such as described in steps 602 and 604 of method 600 and step 702 of method 700. For prior places the private user 101A has lived, the private user 101A may include the date (dates user lived at the location stored in social date data records 125) and location (zip code of location stored in social location data records 126). For specific events the private user 101A has attended (like a concert), the private user 101A may include the date (date of concert stored in social date data records 125), location (street address of concert stored in social location data records 126), and time (hours of the concert, e.g., 6 PM-9 PM EST, stored in social time data records 127). For general characteristics about the private user 101A, the private user 101A may include demographics data (interested in mountain biking stored in social demographics data records 128) and relation data (worked at Wal-Mart, then would add date/location of employment stored in social relation data records 129).

A law enforcement user 101B may have an unsolved homicide case that they enter into the system 100, and they may provide case information to the law enforcement case database 141 to create a comprehensive case dataset 142 for the case, such as described in steps 603 and 605 of method 600 and step 703 of method 700. A case management engine 172 may generate a Case Management System (CMS) on a client device 400 of the law enforcement user 101B that may provide a dashboard to manage the entry of cases and tips received. For characteristics of the homicide the law enforcement user 101B may provide the date data (date of offense which may be stored in case data record 143 and/or case date data records 145), location data (zip code or street address of offense which may be stored in case location data records 146, time and date data (time the homicide is believed to have happened and also known to be last time victim was seen alive which may be stored in case time data records 147 and case date data records 145), demographics data of victim (interested in mountain biking which may be stored in case demographics data records 148, relation data of victim (worked at Wal-Mart (then would add date/location of employment which may be stored in case relation data records 149), and media data (media about the unsolved homicide, such as public photos, video, links to news articles, reporting, etc., which may be stored in case media data records 151).

The system 100 may then compare data from the private user 101A (and all other private users 101A) against all cases in the system database 120 via an association engine 173. Preferably, this includes standard matching of database social data fields 124 and case data fields 144 as well as the use of artificial intelligence and machine learning to calculate probability of linkage based on totality of data entered as described in decision block 606 of method 600 and step 704 of method 700. This may include that matching of social data fields 124 and case data fields 144 such as:

private user 101A linked to unsolved homicide by location data (social location data record 126 of user matches the location of concert of the case location data record 146);

private user 101A linked to unsolved homicide by date data (social date data record 125 matches case date data record 145 showing private user 101A attended same concert as victim);

private user 101A linked to unsolved homicide by time data (social time data record 127 matches case time data record 147 showing private user 101A attended concert at same location at the same date/time as victim as it is known that there are examples where the same performer has multiple shows at a location over multiple days);

private user 101A linked to unsolved homicide by demographics data (social demographics data record 128 of mountain biking matches case demographics data record 148);

private user 101A linked to unsolved homicide by relation data (social relation data record 129 and case relation data record 149 matches showing both worked at Wal-Mart, in which an additional linkage is made if the Wal-Mart was in the same zip code and an additional linkage is made if the private user 101A and victim worked at Wal-Mart during overlapping periods of time.

A notification, preferably a push notification, may be sent to the client device 400 of the private user 101A, notifying them of how they are linked to the unsolved homicide submitted by the law enforcement user 101B as described in step 608 of method 600 and step 707 of method 700. Preferably, the notification (such as by email, SMS, instant message, etc.) may include a link to media data, such as which may be stored in a case media data record 151, directed the private user 101A, and if they choose to click, to a system 100 website where detailed information on the case is contained (photos, videos, news reports, etc.)

Preferably, no information about the private user 101A is ever transmitted or otherwise made available to the law enforcement user 101B unless the private user 101A provides input, via their client device 400, authorizing private user identifying information to be provided to a law enforcement user 101B. In this manner, the private user 101A remains anonymous unless they choose to disclose their identity to the law enforcement user 101B.

The law enforcement user 101B may be notified through their client device 400 that an unsolved case has a connection to an anonymous user private user 101A as described in step 609 of method 600 and step 708 of method 700. Preferably, the match data may be visualized onto a dynamic map 190A, 190B, generated on a display screen 404A of the client device 400 of the law enforcement user 101B showing the concentration of matches or leads/tips geographically as described in step 705 of method 700, but never providing any data that can identify the private user 101A. In this manner, the matches or leads/tips displayed on the dynamic map 190A, 190B, may be visualized to allow law enforcement users 101B to see if a particular geographic location has generated significant activity in order to reallocate investigative resources more efficiently.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g., through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for generating crime solving information by connecting private user information and law enforcement information, the method comprising the steps of:
receiving a private user social dataset having a number of social data fields from a first client device of a private user;
receiving a case dataset describing a case, the case dataset having a number of case data fields from a second client device of a law enforcement user;
identifying a social data field that matches a case data field;
providing a first notification to a first client device of the private user that is associated with the identified social data field requesting the private user to provide crime solving information related to the case dataset;
receiving crime solving information related to the case dataset from the first client device; and
providing crime solving information related to the case dataset to the second client device.

2. The method of claim 1, further comprising the step of providing a second notification to the second client device, the second notification describing that the social data field matches the case data field.

3. The method of claim 1, wherein the first notification comprises data from the case dataset.

4. The method of claim 1, wherein the first notification provides access to media associated with the case.

5. The method of claim 1, wherein at least one of the social data fields of the private user social dataset comprises private user location data generated by the first client device.

6. The method of claim 1, wherein no private user identifying information is provided to the second client device unless the private user provides input, via the first client device, authorizing private user identifying information to be provided to a law enforcement user.

7. The method of claim 1, further comprising the step of generating a dynamic map that shows a geographic concentration of any social data fields that match case data fields.

8. The method of claim 7, wherein the dynamic map shows a concentration of any social data fields that match case data fields by at least one zip code.

9. The method of claim 8, further comprising the step of calculating a probability of solving the case based on the crime solving information received, the geographic concentration, and the number of social data fields matching case data fields.

10. The method of claim 9, wherein the probability of solving a case increases as the number of social data fields matching case data fields increases.

11. A system for generating crime solving information by connecting private user information and law enforcement information, the system comprising:
a private user database having a plurality of private user social datasets, each private user social dataset having a number of social data fields associated with a private user;
a law enforcement case database having a plurality of case datasets, each case dataset having a number of case data fields describing a case;
an association engine, wherein the association engine is configured to identify each private user social dataset having at least one social data field that matches at least one case data field;
a user interface engine that is configured to receive crime solving information related to the case from the client device of each private user that is associated with each identified private user social dataset, and wherein the user interface engine is configured to provide a first notification to a client device of each private user that is associated with each identified private user social dataset, the first notification requesting each private user to provide crime solving information related to the case described by the matched at least one case data field; and
a case management engine that is configured to provide crime solving information related to the law enforcement case dataset to a client device associated with the case.

12. The system of claim 11, wherein the case management engine is configured to provide a second notification to the second client device, the second notification describing that the social data field matches the case data field.

13. The method of claim 11, wherein the first notification comprises data from the case dataset.

14. The method of claim 11, wherein the first notification provides access to media associated with the case.

15. The method of claim 11, wherein at least one of the social data fields of the private user social dataset comprises private user location data generated by the first client device.

16. The method of claim 11, wherein no private user identifying information is provided to the second client device unless the private user provides input, via the first client device, authorizing private user identifying information to be provided to a law enforcement user.

17. The method of claim 11, wherein the association engine is configured to generate a dynamic map that shows a geographic concentration of any social data fields that match case data fields.

18. The method of claim 17, wherein the dynamic map shows a concentration of any social data fields that match case data fields by at least one zip code.

19. The method of claim 18, wherein the association engine is configured to calculate a probability of solving the case based on the crime solving information received, the geographic concentration, and the number of social data fields matching case data fields.

20. The method of claim 19, wherein the probability of solving a case increases as the number of social data fields matching case data fields increases.
